(19) United States
(12) Patent Application Publication
(10) Pub. No.: US 2016/0102723 A1
(43) Pub. Date: Apr. 14, 2016

(54) BRAKE WITH AUDIBLE LOCK-UP WARNING

(71) Applicant: HB Performance Systems, Inc., Mequon, WI (US)

(72) Inventors: Lee A. Pfeil, Elkhart Lake, WI (US); Steve Fiacchino, Port Washington, WI (US); Steve Scheibe, Florence, WI (US); Kurt W. Person, Cedarburg, WI (US)

(21) Appl. No.: 14/878,160

(22) Filed: Oct. 8, 2015

Related U.S. Application Data
(60) Provisional application No. 62/061,520, filed on Oct. 8, 2014.

(51) Int. Cl. F16D 66/00; F16D 55/225

(52) U.S. Cl. CPC F16D 66/00; F16D 55/225; F16D 2066/006

(57) ABSTRACT

The present invention provides a braking system that is designed to give the rider of a vehicle an audible indication of an impending lock-up condition (i.e., a condition where the wheel of a wheeled vehicle or track or a snowmobile is not rotating relative to the vehicle). Preferably, the frequency of the audible indication is proportional to the speed of the wheel or track. In one embodiment, the characteristics of the sound (e.g., frequency) are tuned to achieve an audible indication that can be readily heard and perceived by a rider under specific conditions, such as when the rider is wearing a helmet and also in the presence of other noise, such as engine and exhaust noise. In general, an audible indication in the range of about 6 kHz+/−1 kHz is preferred. The audible indication can be altered by changing the geometry and dimensions of the brake rotor and brake pads.

### BACKGROUND

The present invention relates generally to vehicle brakes, and particularly to systems that allow riders to detect a wheel lock-up condition.

Under most operating conditions, vehicle brakes provide optimal braking when the vehicle traction members (e.g., wheels, belts, or tracks) do not slide relative to the ground, but rather “roll’ relative to the ground. That is, braking forces are compromised when a wheel on a car or a track on a snowmobile is locked up (i.e., not rotating relative to the vehicle) due to the differences between static friction and dynamic friction between the traction member and the ground surface. In addition, when front wheels on a vehicle are locked up, steering of the vehicle can be compromised.

### SUMMARY

The present invention provides a braking system that can be designed to give the user an audible indication of an impending lock-up condition (i.e., a condition where the wheel of a wheeled vehicle or track or a snowmobile is not rotating relative to the vehicle). Preferably, the frequency of the audible indication is proportional to the speed of the wheel or track, which can be sensed by the rider to better control when a lock up condition is imminent, thus allowing the rider to take corrective action, if desired.

In one embodiment, the characteristics of the sound (e.g., frequency) are tuned to achieve an audible indication that can be readily heard and perceived by a rider under specific conditions, such as when the rider is wearing a helmet and also in the presence of other noise, such as engine and exhaust noise. In general, the audible indication is in the range of 4 kHz to 8 kHz, and preferably 6 kHz+/−1 kHz.

The audible indication can be altered by changing the geometry and dimensions of the brake rotor and brake pads. For example, this can involve cutting slots in or changing the edge geometry (e.g., chamfer) of the brake pads, modifying the number, shape, and location of holes in the rotor, or adjusting the amount of caliper piston retraction.

Other aspects of the invention will become apparent by consideration of the detailed description and accompanying drawings.

### BRIEF DESCRIPTION OF THE DRAWINGS

FIG. 1 is a perspective view of a brake assembly including a rotor and a brake pad.

FIG. 2 is a perspective view of the rotor of FIG. 1.

FIG. 3 is a perspective view of the brake pad of FIG. 1.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

### DETAILED DESCRIPTION

The goal with each embodiment of the present invention is to provide a braking system that can be designed to give the rider an audible indication of an impending lock-up condition (i.e., a condition where the wheel of a wheeled vehicle or track or a snowmobile is not rotating relative to the vehicle). In order to improve the feedback information provided by the audible indication, it is preferred that the frequency of the audible indication be proportional to the speed of the wheel or track relative to the brake pad. In other words, as the speed of the wheel or track relative to the pads decreases, the frequency of the audible indication also decreases to provide speed-proportional feedback. This audible indication can be sensed by the rider to better control when a lock up condition occurs. This is most useful on surfaces where tire squeal would not be heard (e.g., on ice, snow, dirt, etc.) and on vehicles that commonly operate on such surfaces (e.g., an ATV, a UTV, a mountain bicycle, or a snow mobile).

The characteristics of the sound (e.g., frequency) can be tuned to achieve a desired audible indication. For example, some sounds are unpleasant and therefore undesirable. In addition, the sound should be such that it can be heard by a rider wearing a helmet. That is, if the rider of the vehicle is wearing a helmet that riders the rider's ears, the desired audible indication might differ (e.g., in frequency and volume) compared to when the rider is not wearing a helmet. Different helmets can also result in different desired audible indications. Also, the sound should be in a different frequency range than the engine or exhaust noise. In general, an audible indication in the range of about 6 kHz+/−1 kHz seems to provide a good sound that is not unpleasant and can be heard by a rider over the engine and exhaust noise.

The audible indication is generated by the dynamic interaction between the brake rotor and brake pads. A specific geometry will cause a shearing effect on the air between the pad and rotor which will emit the desired audible frequency. For example, this can involve cutting slots in or changing the edge geometry (e.g., chamfer) of the brake pads or modifying the number, shape, and location of holes in the rotor. The amount of caliper piston retraction can also influence the sound. This serves to influence sounds that happen due to air motion around or through holes drilled in the rotor disc braking surface face. Having some sound begin as the brake pads get in proximity of the rotor is a useful indication of the imminent onset of braking.

The concept of the present invention could also be used to indicate when the pads are worn by producing a specific audible sound frequency.

Using an audible indication of braking and relative traction between the vehicle drive and the ground surface can be very useful in many off pavement environments where maximizing brake performance and maneuverability is largely dependent on controlling rolling friction between the vehicle drive and the ground. Once the drive system is locked up and traction has changed to a pure sliding event, operator control of the vehicle has been compromised.

As noted above, the described embodiments of the present invention utilize passive sound generated by the air shearing between the rotor and pads in order to achieve speed-proportional audible feedback. However, in other embodiments, it is possible to generate an active sound that accomplishes the same speed-proportional audible feedback using electronic sensors, software, and speakers to signal to the rider what is happening within a braking event.

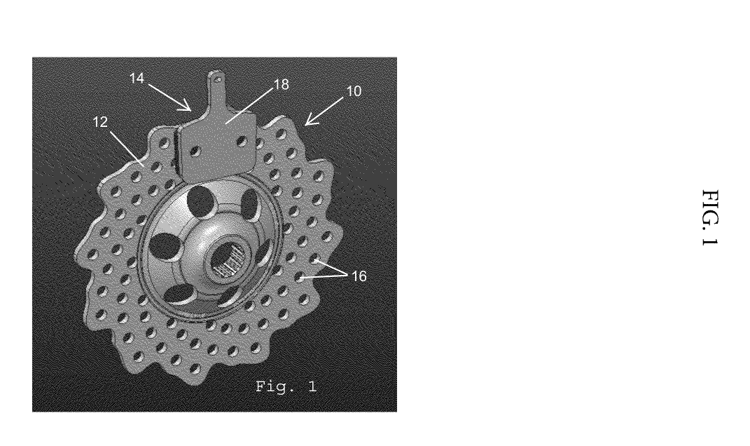

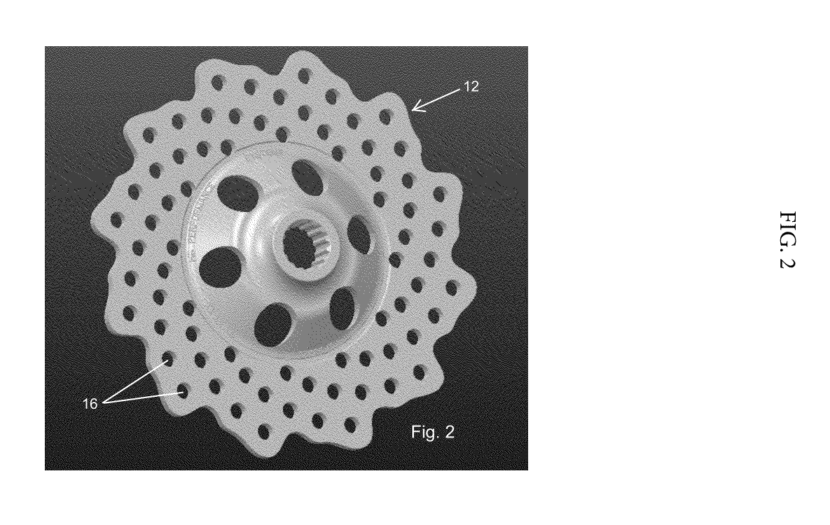

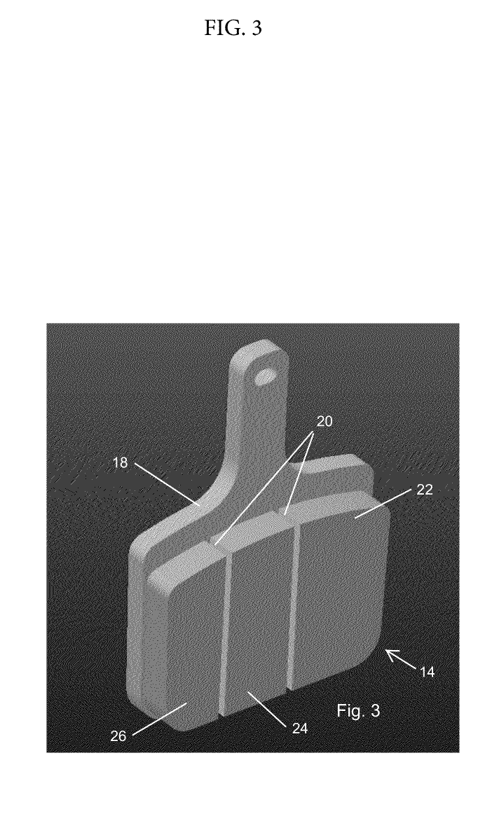

FIGS. 1-3 illustrate a brake assembly 10 embodying the present invention. The brake assembly 10 includes a rotor 12 and a brake pad 14. The rotor 12 includes a series of holes 16 extending through the rotor 12. The holes 16 have a diameter of 8 mm and are arranged in a series of arching spirals of six holes each. The center of each hole 16 of a spiral is angularly spaced about 10.249 degrees and radially spaced about 6.1 mm from the other holes in the same spiral. In the illustrated embodiment, there are twelve spirals of six holes each, for a total of seventy-two holes 16. The portion of the rotor through which the holes are position has a thickness of about 5 mm.

The illustrated brake pad 14 is supported on a holder 18 and includes two slots 20 extending through the pad 14 to thereby separate the pad into three parts 22, 24, 26. Each slot is about 1 mm in width. The slots 20 are asymmetrical relative to the pad 14 such that the first part 22 is wider than the second part 24, which is wider than the third part 26.

Various features and advantages of the invention are set forth in the following claims.

1. A method of providing feedback regarding vehicle braking to a rider of a vehicle having a chassis and brakes affecting movement of a traction member relative to the chassis, comprising:
applying the brakes;
generating a sound having a frequency that is proportional to movement of the traction member relative to the chassis; and
controlling braking based on the sound.

2. A method as claimed in claim 1, wherein the brake include a rotor coupled for rotation with the traction member and a brake pad mounted to the chassis, and wherein the applying step include moving the pad toward the rotor.

3. A method as claimed in claim 2, wherein the frequency of the sound is proportional to a speed of the rotor relative to the brake pad.

4. A method as claimed in claim 1, wherein the traction member comprises at least one of a wheel and a track.

5. A method as claimed in claim 1, wherein the step of applying is initiated by the rider.

6. A method as claimed in claim 1, wherein the generating step includes creating the sound having a frequency of 5 kHz to 7 kHz.

7. A method as claimed in claim 1, wherein the vehicle is one of an ATV, a UTV, and a snow mobile.

8. A method of creating a speed proportional sound on a vehicle, comprising:
providing a vehicle brake having a rotor, a caliper piston, and a pad; and
adjusting one or more of:
a pad leading edge profile,
a size, depth or position of orifices in the rotor, or
a retraction distance of the caliper piston to achieve a desired sound.

9. A method as claimed in claim 8, wherein the vehicle comprises an ATV, a UTV, or a snow mobile.
